(19) United States
(12) Patent Application Publication
(10) Pub. No.: US 2024/0239370 A1
(43) Pub. Date: Jul. 18, 2024

(54) Method and Device for Determining a Driving Trajectory for a Repeated Performance of a Driving Maneuver

(71) Applicant: Bayerische Motoren Werke Aktiengesellschaft, Muenchen (DE)

(72) Inventors: Daniel TELSCHOW, Muenchen (DE); Rebecca Pascal, Muenchen (DE); Benjamin Krimmer, Muenchen (DE); Benedikt Hoffmann, Muenchen (DE); Mohamad Mounir El Dana, Muenchen (DE)

(21) Appl. No.: 18/411,192

(22) Filed: Jan. 12, 2024

(30) Foreign Application Priority Data
Jan. 18, 2023 (DE) 10 2023 101 090.5

(51) Int. Cl. B60W 60/00; B60W 50/04; B60W 50/06

(52) U.S. Cl. CPC B60W 60/001; B60W 50/045; B60W 50/06

(57) ABSTRACT

A device for determining a driving trajectory for repeated performance of a vehicle maneuver is disclosed. The device is configured to determine that a driving trajectory recorded for the driving maneuver exceeds a system limit of the vehicle for the automated performance of the driving maneuver. The device is further configured to determine a driving trajectory for the driving maneuver which is adapted with regard to the recorded driving trajectory and does not exceed the system limit of the vehicle, and to provide and/or use the adapted driving trajectory for automated performance of the driving maneuver.

### CROSS REFERENCE TO RELATED APPLICATIONS

This application claims priority under 35 U.S.C. § 119 from German patent application Ser. No. 10/202,3101090.5, filed Jan. 13, 2023, the entire disclosure of which is herein expressly incorporated by reference.

### BACKGROUND AND SUMMARY

The invention relates to a method and a corresponding device, which are configured to enable a previously recorded driving maneuver to be carried out repeatedly.

A vehicle may include a driver assistance system which enables the user of the vehicle to record and store a driving trajectory driven in manual driving mode for a driving maneuver. The recorded and stored driving trajectory can be used at a later time to automatically guide the vehicle along the recorded driving trajectory. In this way, the comfort of the vehicle can be increased when repeating the performance of driving maneuvers.

The present document deals with the technical problem of increasing the availability of a driver assistance system for repeated performance of a driving maneuver in an efficient and reliable manner.

The problem is solved by each of the independent claims. Advantageous embodiments are described, inter alia, in the dependent claims. It should be noted that additional features of a claim dependent on an independent patent claim without the features of the independent patent claim or only in combination with a subset of the features of the independent patent claim may form a separate invention independent of the combination of all features of the independent patent claim, which may be made the subject of an independent claim, a divisional application or a subsequent application. This applies in the same way to technical teachings described in the description, which can form an invention independent of the features of the independent claims.

According to one aspect, a device is described for determining a driving trajectory (or a driving path, respectively) for repeated performance of a driving maneuver, in particular a parking maneuver, of a (motor) vehicle. The device is designed to recognize that a driving trajectory recorded for the driving maneuver exceeds a system limit of the vehicle for automated performance of the driving maneuver. In particular, it can be determined that the recorded driving trajectory exceeds a system limit of the vehicle, which exists when the vehicle is automatically guided longitudinally and/or laterally, but is not present when the vehicle is guided manually.

The system limit may include:
a system limit with regard to the maximum possible steering angle and/or with respect to the maximum possible time gradient of a change in the steering angle;
a system limit with regard to the maximum possible driving speed and/or the maximum possible acceleration of the vehicle; and/or
a system limit with regard to the (permitted) minimum distance between the vehicle and an environmental object.

Higher values may be available for the individual system limits for manual longitudinal and/or transverse guidance than for automated longitudinal and/or lateral guidance. As a result, when recording the trajectory (which is driven in manual driving mode with manual longitudinal and/or lateral guidance), the driver may exceed at least one system limit that applies to the automated driving mode (with automated longitudinal and/or lateral guidance).

The device may be configured to record, in a recording mode (of the driver assistance system), a trajectory driven by the vehicle when the driving maneuver is carried out in order to determine the recorded trajectory. In the recording mode, when performing the driving maneuver, the longitudinal and/or lateral guidance of the vehicle can be caused manually by the driver of the vehicle.

As part of recording the driving trajectory, trajectory data can be acquired and recorded. The trajectory data can specify in each case for a plurality of points and/or positions along the driving trajectory (starting from a start position to an end position of the trajectory):
the coordinates of the respective position;
the orientation and/or orientation of the vehicle at the respective position; and/or
the speed of the vehicle at the respective position.

The trajectory data of the driving trajectory can be stored in a memory unit of the vehicle. Furthermore, the trajectory data can be used in a replay mode to guide the vehicle automatically (with automated longitudinal and/or lateral guidance) along the driving trajectory (from the initial position to the end position of the driving trajectory).

The device is configured to determine a driving trajectory adapted to the recorded driving trajectory for the driving maneuver. The adapted trajectory can be determined in such a way that the adapted trajectory does not exceed the system limit (in particular all system limits) of the vehicle (for automatically performing the driving maneuver). Furthermore, the adapted trajectory can be determined in such a way that the start position of the adjusted trajectory and the recorded trajectory and/or the end position of the adjusted trajectory and the recorded trajectory are the same.

Alternatively or additionally, the adapted trajectory can be determined in such a way that the adapted trajectory reduces, in particular minimizes, a cost function. The cost function can be designed to reduce, in particular minimize, the deviation of the adjusted trajectory from the recorded trajectory. The one or more system limits can be considered in each case as a secondary condition when reducing the cost function.

Furthermore, the device is configured to provide and/or use the adapted driving trajectory for automated performance of the driving maneuver. In particular, in the replay mode, the driving maneuver can be carried out automatically on the basis of the adapted trajectory. When the driving maneuver is carried out automatically, the longitudinal and/or lateral guidance of the vehicle can be caused automatically by the vehicle.

By using an adapted trajectory for the automated performance of the driving maneuver, the availability of the driver assistance system to assist a driver in repeating the performance of driving maneuvers can be increased in an efficient and reliable manner.

The device may be set up to determine the adapted trajectory in such a way that the number of driving moves in the adapted trajectory is higher than the number of driving moves in the recorded trajectory. Alternatively or additionally, the adapted trajectory can be determined in such a way that the adapted trajectory comprises at least one additional driving move (and an associated change of direction of driving) that is not included in the recorded trajectory. The adapted trajectory may in particular include at least or exactly two additional driving moves (and corresponding changes of direction). In this way, the one or more system limits can be met in a particularly reliable manner.

A driving move may be a section of the respective trajectory, which the vehicle drives through in a uniform direction of travel (forward or backward). The direction of travel is typically changed between two directly consecutive driving moves (from forward to backward, or from backward to forward). By adding one or more additional driving moves and/or changes of direction, the quality and/or reliability of the adapted trajectory and thus of the driver assistance system can be further increased.

The device may be configured to determine, in particular in response to a user input (at a vehicle user interface), that the trajectory recorded in recording mode should be stored permanently in the memory unit (of the vehicle) following the (manual) performance of the driving maneuver. The adjusted trajectory can then be determined directly in response to the determination that the recorded trajectory should be stored. The recorded trajectory can therefore be adjusted directly following the recording of the trajectory.

The adapted trajectory, in particular instead of the recorded trajectory, can also be caused to be stored in the memory unit (of the vehicle). An adapted trajectory can thus be caused to be determined for the driving maneuver directly following the recording and to be stored permanently in the memory unit. In such cases, permanent storage of the recorded trajectory may possibly be dispensed with. The driver assistance system can thus be provided in a particularly robust and efficient manner.

Alternatively or additionally, the device may be configured to determine, in particular in response to a user input (at the vehicle user interface), that the driving maneuver should be carried out automatically in the replay mode. The adapted trajectory can then be determined (possibly only) in response to determining that performance of the driving maneuver is to be caused automatically on the basis of the recorded trajectory stored in the memory unit of the vehicle. If necessary, current environmental data from one or more environmental sensors (e.g. a camera, a radar sensor, a lidar sensor, etc.) can be taken into account directly. It is therefore possible to specifically determine the adjusted trajectory for a specific repeated performance of the driving maneuver. The driver assistance system can thus be provided in a particularly flexible manner.

The device may be configured to recognize that the recorded trajectory comprises at least one unnecessary driving move, which is not necessary to guide the vehicle (without collision) from the start position to the end position. The adapted trajectory can be determined in such a way that the adapted trajectory does not include the unnecessary driving move. It may therefore be possible to reduce the number of driving moves. By removing an unnecessary driving move, the comfort and speed of performance of the driver assistance system can be increased.

According to a further aspect, a (road) motor vehicle (in particular a passenger car or a truck or a bus or a motorcycle) is described, which comprises the device described in this document.

According to a further aspect, a method for determining a driving trajectory for repeated performance of a driving maneuver of a (motor) vehicle is described. The method comprises detecting that a driving trajectory recorded for the driving maneuver exceeds (at least) a system limit of the vehicle for automated performance of the driving maneuver. The method also comprises determining a driving trajectory for the driving maneuver that is adapted to the recorded driving trajectory, in such a way that the adapted driving trajectory does not exceed the system limit of the vehicle (and possibly deviates as little as possible from the recorded driving trajectory). The method also comprises providing and/or using the adapted driving trajectory for automated performance of the driving maneuver.

According to another aspect, a software (SW) program is described. The SW program can be configured to be executed on a processor (for example on a vehicle control device) and thus to perform the method described in this document.

According to a further aspect, a storage medium is described. The storage medium may include an SW program which is configured to be executed on a processor and thus to perform the method described in this document.

It should be noted that the methods, devices and systems described in this document can be used alone or in combination with other methods, devices and systems described in this document. Furthermore, any aspect of the methods, devices and systems described in this document may be combined in a variety of ways. In particular, the features of the claims can be combined with one another in a variety of ways. Furthermore, features listed in parentheses are to be understood as optional features.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIGS. 2A to 2D each show an exemplary recorded and an exemplary adapted driving trajectory for a driving maneuver; and

FIG. 3 is a flow chart of an exemplary method for adapting a driving trajectory for the repeated performance of a driving maneuver.

### DETAILED DESCRIPTION OF THE DRAWINGS

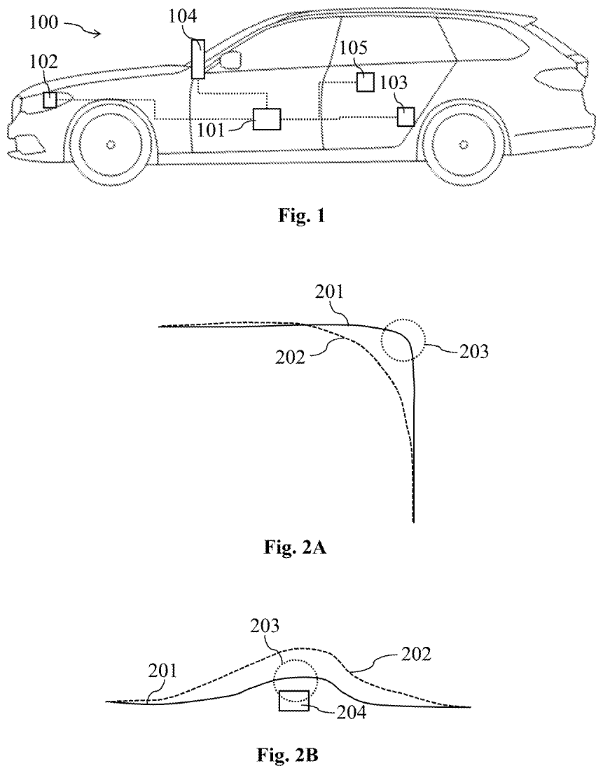

As explained above, the present document relates to increasing the availability of a driver assistance system for repeated performance of a driving maneuver, in particular a parking maneuver. In this context, FIG. 1 shows an exemplary vehicle 100 with one or more environmental sensors 102 (e.g. at least one camera, at least one radar sensor, at least one lidar sensor, at least one ultrasonic sensor, etc.), which are each set up to detect environmental data (i.e. sensor data) relating to the environment of the vehicle 100. A control device 101 of the vehicle 100 may be configured to evaluate the environmental data in order to detect one or more objects in the vicinity of the vehicle 100.

The control device 101 may also be configured to operate one or more longitudinal and/or transverse guidance actuators 103 of the vehicle 100 (for example a drive motor, a brake device and/or a steering device) in order to automatically guide the vehicle 100 longitudinally and/or transversely. The one or more actuators 103 can be operated as a function of the environmental data, in particular as a function of the one or more detected objects.

The vehicle 100 may also include a user interface 104, which enables interaction between the user and the vehicle 100, for example to activate or deactivate a driver assistance system and/or to inform the user about the status of a driver assistance system. The user interface 104 may include one or more operating elements and/or one or more output elements (e.g. a screen).

The vehicle 100 may include a driver assistance system which is designed to record a driving trajectory driven by the vehicle 100. The driving trajectory can be driven manually by the driver of the vehicle 100 and/or automatically through the vehicle 100. Trajectory data relating to the driving trajectory can be stored in a memory unit 105 of the vehicle 100. The trajectory data can each display for a variety of positions along the driving trajectory,
coordinates of the respective position (for example relative to a world coordinate system and/or relative to a coordinate system of the vehicle 100);
the orientation and/or heading of the vehicle 100 at the respective position; and/or
the driving speed of vehicle 100 at the respective position.

The recording of a driving trajectory can be started and/or stopped explicitly by the user of the vehicle 100 (via the user interface 104). In this way, the start position and/or the end position of the stored driving trajectory can be determined precisely.

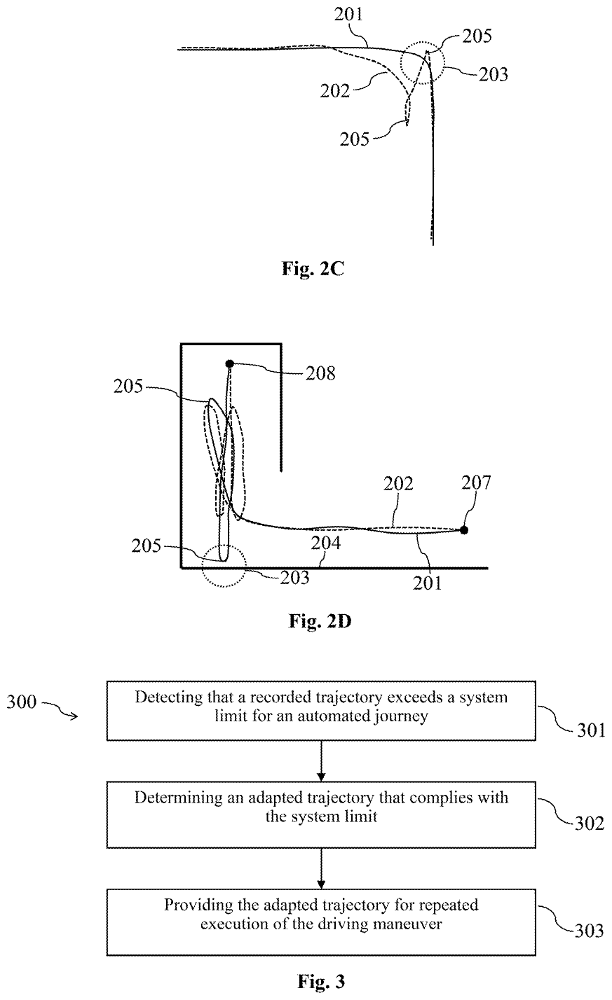

FIGS. 2A and 2B show exemplary recorded driving trajectories 201 for various driving maneuvers. The driving trajectories 201 may each have been recorded as part of a manual journey and may have been stored in the memory unit 105.

The control device 101 may be configured to analyze a recorded driving trajectory 201. This can be done, for example, after the manual drive to record the driving trajectory 201 and/or in advance of the respective driving maneuver being carried out repeatedly. As part of the analysis of the recorded driving trajectory 201, it can be determined that the driving trajectory 201 exceeds a system limit of the vehicle 100 for the automated performance of the driving maneuver. This may be a system limit which exists for the automated performance of the driving maneuver (with automated longitudinal and/or lateral guidance of the vehicle 100), but which does not exist for the manual performance of the driving maneuver (with manual longitudinal and/or lateral guidance of the vehicle 100).

Exemplary system limits are:
a system limit with respect to the maximum possible steering angle of the vehicle 100;
a system limit in terms of the maximum possible time gradient for changing the steering angle;
a system limit with respect to the driving speed and/or with respect to the acceleration of the vehicle 100; and/or
a system limit in terms of the minimum distance to be maintained from an environmental object along the driving trajectory.

As part of the analysis of the recorded driving trajectory 201, it can be seen, for example, in the example of FIG. 2A and FIG. 2C that the recorded trajectory 201 exceeds the maximum possible steering angle as system limit 203. In the example in FIG. 2B, it can be seen that the recorded driving trajectory 201, as system limit 203, is below the minimum distance to be maintained from an environmental object 204.

The control device 101 may also be configured to adapt the recorded trajectory 201 in such a way that the adapted trajectory 202 complies with the one or more system limits 203 for the automated performance of the driving maneuver. For this purpose, for example, an adapted trajectory 202 can be determined which, compared to the recorded trajectory 201, has a reduced (potentially maximum) curvature (FIG. 2A) and/or an increased distance from an environmental object 204 (FIG. 2B). Alternatively or additionally, one or more additional driving moves, each with a change of direction of travel 205, can be introduced into the adapted trajectory 202 (FIG. 2C).

FIG. 2D shows an example in which the driver of the vehicle 100 has manually driven and recorded a trajectory 201 in order to reach the parking bay shown in FIG. 2D. The recorded trajectory 201 runs from a start position 207 to an end position 208 and comprises a total of three driving moves and/or corresponding changes of direction of travel 205. Furthermore, at a specific point, the recorded trajectory 201 falls below the minimum allowable distance from a wall at the parking bay (i.e. from an environmental object 204). A system limit 203 of the driver assistance system is therefore exceeded for the automated performance of the driving maneuver corresponding to the recorded trajectory 201.

The device 101 of the vehicle 100 is configured to determine an adapted trajectory 202 on the basis of the recorded trajectory 201, wherein the adapted trajectory 202 does not exceed the system limit 203. For this purpose, the adapted trajectory 202 may include one or more additional driving moves and/or corresponding changes of direction of travel 205, which are not included in the recorded trajectory 201. In the example shown in FIG. 2D, the adapted trajectory 202 includes two additional driving moves and/or corresponding changes of direction of travel 205 (i.e. the adapted trajectory 202 has a total of five driving moves and/or changes of direction of travel 205). In this way, it can be reliably ensured that the minimum distance from the wall is not exceeded (and therefore the system limit 203 is not exceeded).

The adapted trajectory 202 can be determined in such a way that the recorded trajectory 201 and the corresponding adapted trajectory 202 have the same start position 207 on the one hand and/or the same end position 208 on the other hand.

As explained above, when a driving maneuver is carried out repeatedly, for example due to localization problems and/or localization inaccuracies and/or a limitation of the steering angle, the recorded path 201 cannot be followed. This may result in the termination of the performance of the driver assistance system. Furthermore, the fact that the driver causes a relatively large number of driving moves when recording a path 201 can lead to the repeated performance of the driving maneuver in accordance with the recorded path 201 taking a relatively long execution time and/or to blocking other road users when the driving maneuver is carried out repeatedly.

As described in this document, dynamic path planning can be carried out differently from the recorded driving trajectory 201 (for example at bottlenecks). In this case, the driver assistance system may be configured (depending on the conditions in the environment of the recorded trajectory 201) to schedule one or more additional driving moves for the adapted driving trajectory 202, in particular to prevent termination of the execution of the driver assistance system and/or to prevent the vehicle 100 from getting stuck. Alternatively or additionally, the recorded path 201 can be optimized by reducing the number of driving moves, for example in order to reduce the execution time of the driving maneuver.

When a driving maneuver is carried out repeatedly based on a recorded trajectory 201, for example when driving through a curve having a lateral boundary, it can be determined that the recorded trajectory 201 cannot be followed (for example due to localization difficulties and/or due to a steering angle with limited usability). The control device 101 may be configured (as soon as the lateral boundary is recognized) to schedule an additional driving move (and thus to determine an adapted trajectory 202), in particular to be able to drive past the boundary automatically.

In another example, as part of a manually driven driving maneuver, a driving trajectory 201 may have been recorded by the user, which comprises a specific number of driving moves (for example to park in a perpendicular parking space). In order to repeat performance of the driving maneuver (automatically), an optimized (adapted) trajectory 202 can be determined, which includes fewer driving moves than the recorded trajectory 201.

FIG. 3 shows a flow chart of a (possibly computer-implemented) method 300 for determining a driving trajectory for repeated performance of a driving maneuver, in particular a parking maneuver, of a (motor) vehicle 100. The method 300 comprises determining 301 that a driving trajectory 201 recorded for the driving maneuver exceeds a system limit 203 of the vehicle 100 for automated performance of the driving maneuver. The parking maneuver used to record the driving trajectory 201 may have been performed manually by the driver of the vehicle 100 (with manual longitudinal and/or lateral guidance).

The method 300 further comprises determining 302 a driving trajectory 202 adapted to the recorded driving trajectory 201 for the driving maneuver, wherein the adapted driving trajectory 202 does not exceed the system limit 203 of the vehicle 100. The adapted driving trajectory 202 can be determined using a cost function based on the recorded driving trajectory 201, for example in such a way that the value of the cost function is reduced, in particular minimized. The cost function may depend on the deviation, for example the mean quadratic and/or mean absolute deviation, of the adjusted driving trajectory 202 from the recorded driving trajectory 201. Furthermore, when determining the adjusted driving trajectory 202, the one or more system limits 203 of the vehicle 100 can each be taken into account as a secondary condition to be met.

The method 300 further comprises providing and/or using 303 the adapted driving trajectory 202 for automated performance of the driving maneuver (with automated longitudinal and/or lateral guidance).

The measures described in this document, may efficiently increase the availability and/or reliability of a driver assistance system for repeated performance of a driving maneuver.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for determining a driving trajectory for repeated performance of a driving maneuver of a vehicle, the device comprising:
a control device operatively configured to:
determine that a driving trajectory recorded for the driving maneuver exceeds a system limit of the vehicle for automated performance of the driving maneuver;
determine, for the driving maneuver, a driving trajectory adapted with regard to the recorded driving trajectory, wherein the adapted driving trajectory does not exceed the system limit of the vehicle; and
provide and/or use the adapted driving trajectory for automated performance of the driving maneuver.

2. The device according to claim 1, wherein the control device is further configured to:
determine that the recorded driving trajectory exceeds a system limit of the vehicle, wherein
the system limit applies during automated longitudinal control and/or automated lateral control of the vehicle, and
the system limit does not apply during manual control of the vehicle.

3. The device according to claim 2, wherein the system limit comprises one or more of:
a system limit with regard to a maximum possible steering angle and/or with regard to a maximum possible time gradient of a change in the steering angle;
a system limit with regard to a maximum possible driving speed and/or acceleration of the vehicle; or
a system limit with regard to a minimum distance between the vehicle and an environmental object.

4. The device according to claim 1, wherein
the recorded trajectory extends from a start position to an end position; and
the control device is further configured to determine the adapted trajectory with the start position of the adapted trajectory and the recorded trajectory and/or the end position of the adapted trajectory and the recorded trajectory coinciding.

5. The device according to claim 1, wherein the control device is configured to determine the adapted trajectory so that:
a number of driving moves in the adapted trajectory is higher than the number of driving moves in the recorded trajectory, and/or
the adapted trajectory includes at least one additional driving move not included in the recorded trajectory.

6. The device according to claim 5, wherein the adapted trajectory includes at least or exactly two additional driving moves not included in the recorded trajectory.

7. The device according to claim 1, wherein the control device is further configured to:
record, in a recording mode, a trajectory driven by the vehicle when performing the driving maneuver in order to determine the recorded trajectory; and
perform, in a replay mode, the driving maneuver automatically based on the adapted trajectory, wherein during the automated performance of the driving maneuver the longitudinal control and/or lateral control of the vehicle is performed automatically by the vehicle.

8. The device according to claim 7, wherein, during performance of the driving maneuver in the recording mode, the longitudinal control and/or lateral control of the vehicle is performed manually by a driver of the vehicle.

9. The device according to claim 7, wherein the control device is further configured to:
determine, in response to a user input, that the trajectory recorded in the recording mode should be stored in a memory unit after the driving maneuver has been performed;
determine the adapted trajectory in response to determining that the recorded trajectory should be stored; and
cause the adapted trajectory to be stored in the storage unit instead of the recorded trajectory.

10. The device according to claim 1, wherein the control device is further configured to:
determine, in response to a user input, that the driving maneuver should be carried out automatically in a replay mode; and
determine the adapted trajectory based on the recorded trajectory stored in a memory unit of the vehicle in response to the determination that the driving maneuver should be automatically performed.

11. The device according to claim 1, wherein the control device is further configured to:
recognize that the recorded trajectory comprises at least one unnecessary driving move which is not required to guide the vehicle from a start position to an end position; and
determine the adapted trajectory so that the adapted trajectory does not include the unnecessary driving move.

12. A method for determining a driving trajectory for repeated performance of a driving maneuver of a vehicle, the method comprising:
detecting that a driving trajectory recorded for the driving maneuver exceeds a system limit of the vehicle for automated performance of the driving maneuver;
determining, for the driving maneuver, a driving trajectory adapted with regard to the recorded driving trajectory, wherein the adapted driving trajectory does not exceed the system limit of the vehicle; and
providing and/or using the adapted driving trajectory for automated performance of the driving maneuver.
